(19) United States
(12) Patent Application Publication
(10) Pub. No.: US 2025/0016599 A1
(43) Pub. Date: Jan. 9, 2025

(54) METHOD FOR ASSISTING IN REPORTING AND FOR RESTORING CHANNEL CHARACTERISTIC INFORMATION, TERMINAL, AND NETWORK SIDE DEVICE

(71) Applicant: VIVO MOBILE COMMUNICATION CO., LTD., Dongguan (CN)

(72) Inventors: Qianyao REN, Dongguan (CN); Bule SUN, Dongguan (CN); Ang YANG, Dongguan (CN)

(73) Assignee: VIVO MOBILE COMMUNICATION CO., LTD., Dongguan (CN)

(21) Appl. No.: 18/892,333

(22) Filed: Sep. 20, 2024

Related U.S. Application Data
(63) Continuation of application No. PCT/CN2023/082129, filed on Mar. 17, 2023.

(30) Foreign Application Priority Data
Mar. 21, 2022 (CN) 202210281152.8

(51) Int. Cl. H04W 24/10; H04W 24/02

(52) U.S. Cl. CPC H04W 24/10; H04W 24/02

(57) ABSTRACT

This application discloses methods for assisting in reporting and for restoring channel characteristic information, a terminal, and a network side device. The method includes: processing, by a terminal, first channel information into target channel characteristic information by using a first AI network model; and sending, by the terminal, the target channel characteristic information to a network side device, and sending first information to the network side device. The first information includes at least one of first indication information or target assistance information. The first indication information indicates accuracy of second channel information recovered based on the target channel characteristic information or indicates information for assisting the network side device in determining the accuracy of the second channel information, and the target assistance information is used to assist the network side device in recovering the second channel information based on the target channel characteristic information.

### CROSS-REFERENCE TO RELATED APPLICATIONS

This application is a continuation of International Application No. PCT/CN 2023/082129, filed on Mar. 17, 2023, which claims priority to Chinese Patent Application No. 202210281152.8, filed on Mar. 21, 2022. The entire contents of each of the above-referenced applications are expressly incorporated herein by reference.

### TECHNICAL FIELD

This application pertains to the field of communication technologies, and in particular, to a method for assisting in reporting and for restoring channel characteristic information, a terminal, and a network side device.

### BACKGROUND

With the application of artificial intelligence (Artificial Intelligence, AI) in the communication field, channel state information (Channel State Information, CSI) may be coded and decoded by using an AI network model.

However, with the change of channel quality, a matching degree between an AI network model and a channel state may decrease, resulting in reduced accuracy of a result obtained after the AI network model codes or decodes CSI.

### SUMMARY

Embodiments of this application provide a method for assisting in reporting and for restoring channel characteristic information, a terminal, and a network side device. After obtaining the channel characteristic information through coding by using an AI network model, the terminal can report assistance information related to decoding the channel characteristic information or indication information that can reflect accuracy of the channel characteristic information to the network side device, so that the network side device can improve accuracy of a decoded result of the channel characteristic information based on the assistance information or the indication information.

According to a first aspect, a method for assisting in reporting channel characteristic information is provided, and the method includes the following steps:

A terminal processes first channel information into target channel characteristic information by using a first AI network model.

The terminal sends the target channel characteristic information to a network side device, and sending first information to the network side device, where the first information includes at least one of first indication information or target assistance information.

The first indication information indicates accuracy of second channel information recovered based on the target channel characteristic information or indicates information for assisting the network side device in determining the accuracy of the second channel information, and the target assistance information is used to assist the network side device in recovering the second channel information based on the target channel characteristic information.

According to a second aspect, an apparatus for assisting in reporting channel characteristic information is provided, where the apparatus is applied to a terminal and includes: a first processing module, configured to process first channel information into target channel characteristic information by using a first AI network model; and a first sending module, configured to: send the target channel characteristic information to a network side device, and send first information to the network side device, where the first information includes at least one of first indication information or target assistance information, where the first indication information indicates accuracy of second channel information recovered based on the target channel characteristic information or indicates information for assisting the network side device in determining the accuracy of the second channel information, and the target assistance information is used to assist the network side device in recovering the second channel information based on the target channel characteristic information.

According to a third aspect, a method for restoring channel characteristic information is provided, including the following step:

A network side device obtains first information from a terminal, and obtains target channel characteristic information from the terminal, where the first information includes at least one of first indication information or target assistance information, the first indication information indicates accuracy of second channel information recovered based on the target channel characteristic information or indicates information for assisting the network side device in determining the accuracy of the second channel information, and the target assistance information is used to assist the network side device in recovering the second channel information based on the target channel characteristic information.

The network side device determines the second channel information based on a channel recovery result of the target channel characteristic information obtained by using a third AI network model and the first information.

According to a fourth aspect, an apparatus for restoring channel characteristic information is provided, where the apparatus is applied to a network side device and includes:
a second obtaining module, configured to: obtain first information from a terminal, and obtain target channel characteristic information from the terminal, where the first information includes at least one of first indication information or target assistance information, the first indication information indicates accuracy of second channel information recovered based on the target channel characteristic information or indicates information for assisting the network side device in determining the accuracy of the second channel information, and the target assistance information is used to assist the network side device in recovering the second channel information based on the target channel characteristic information; and
a second determining module, configured to determine the second channel information based on a channel recovery result of the target channel characteristic information obtained by using a third AI network model and the first information.

According to a fifth aspect, a terminal is provided. The terminal includes a processor and a memory, the memory stores a program or an instruction that can be run on the processor, and the program or the instruction is executed by the processor to implement the steps of the method according to the first aspect.

According to a sixth aspect, a terminal is provided, including a processor and a communication interface. The processor is configured to process first channel information into target channel characteristic information by using a first AI network model; and the communication interface is configured to: send the target channel characteristic information to a network side device, and send first information to the network side device, where the first information includes at least one of first indication information or target assistance information, where the first indication information indicates accuracy of second channel information recovered based on the target channel characteristic information or indicates information for assisting the network side device in determining the accuracy of the second channel information, and the target assistance information is used to assist the network side device in recovering the second channel information based on the target channel characteristic information.

According to a seventh aspect, a network side device is provided. The network side device includes a processor and a memory, the memory stores a program or an instruction that can be run on the processor, and the program or the instruction is executed by the processor to implement the steps of the method according to the third aspect.

According to an eighth aspect, a network side device is provided, including a processor and a communication interface. The communication interface is configured to: obtain first information from a terminal, and obtain target channel characteristic information from the terminal, where the first information includes at least one of first indication information or target assistance information, the first indication information indicates accuracy of second channel information recovered based on the target channel characteristic information or indicates information for assisting the network side device in determining the accuracy of the second channel information, and the target assistance information is used to assist the network side device in recovering the second channel information based on the target channel characteristic information; and the processor is configured to determine the second channel information based on a channel recovery result of the target channel characteristic information obtained by using a third AI network model and the first information.

According to a ninth aspect, a communication system is provided, including: a terminal and a network side device, where the terminal may be configured to perform the steps of the method for assisting in reporting channel characteristic information according to the first aspect, and the network side device may be configured to perform the steps of the method for restoring channel characteristic information according to the third aspect.

According to a tenth aspect, a readable storage medium is provided. The readable storage medium stores a program or an instruction, and when the program or the instruction is executed by a processor, the steps of the method according to the first aspect or the steps of the method according to the third aspect are implemented.

According to an eleventh aspect, a chip is provided. The chip includes a processor and a communication interface, the communication interface is coupled to the processor, and the processor is configured to run a program or an instruction to implement the method according to the first aspect or the third aspect.

According to a twelfth aspect, a computer program/program product is provided. The computer program/program product is stored in a storage medium, and the computer program/program product is executed by at least one processor to implement the steps of the method for assisting in reporting channel characteristic information according to the first aspect or the steps of the method for restoring channel characteristic information according to the third aspect.

In the embodiments of this application, the terminal may determine a first AI network model matching a current channel state based on indication of the network side device, a detected channel state, or the like, use the first AI network model to process channel information into coding information (namely, target channel characteristic information) in a length corresponding to the first AI network model, and report all or part of the target channel characteristic information to the network side device. In addition, the terminal further reports first information to the network side device, to inform the network side device of accuracy of second channel information recovered based on the target channel characteristic information, or to indicate information that is used to assist the network side device in determining the accuracy of the second channel information, and/or to report target assistance information that may be used to assist the network side device in recovering the second channel information based on the target channel characteristic information to the network side device. In this way, the network side device may determine, based on the accuracy of the second channel information recovered based on the target channel characteristic information or the accuracy of the first channel information, whether the third AI network model and the first AI network model need to be updated; and/or determine, based on reliability of the second channel information recovered by the network side device, whether to use the target assistance information to assist recovery of the second channel information, so that the accuracy of the result obtained after the AI network model codes or decodes the channel characteristic information can be improved.

### BRIEF DESCRIPTION OF THE DRAWINGS

FIG. 1 is a schematic diagram of a structure of a wireless communication system to which embodiments of this application can be applied;

FIG. 2 is a flowchart of a method for assisting in reporting channel characteristic information according to an embodiment of this application;

FIG. 3 is a schematic diagram of an architecture of a neural network model;

FIG. 4 is a schematic diagram of a neuron;

FIG. 5a is a first schematic diagram of an application scenario of an AI network model according to an embodiment of this application;

FIG. 5b is a second schematic diagram of an application scenario of an AI network model according to an embodiment of this application;

FIG. 5c is a third schematic diagram of an application scenario of an AI network model according to an embodiment of this application;

FIG. 5d is a fourth schematic diagram of an application scenario of an AI network model according to an embodiment of this application;

FIG. 5e is a fifth schematic diagram of an application scenario of an AI network model according to an embodiment of this application;

FIG. 6 is a flowchart of a method for restoring channel characteristic information according to an embodiment of this application;

FIG. 7 is a schematic diagram of a structure of an apparatus for assisting in reporting channel characteristic information according to an embodiment of this application;

FIG. 8 is a schematic diagram of a structure of an apparatus for restoring channel characteristic information according to an embodiment of this application;

FIG. 9 is a schematic diagram of a structure of a communication device according to an embodiment of this application;

FIG. 10 is a schematic diagram of a structure of a terminal according to an embodiment of this application; and

FIG. 11 is a schematic diagram of a structure of a network side device according to an embodiment of this application.

### DETAILED DESCRIPTION

The following clearly describes technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in the specification and claims of this application are used to distinguish between similar objects instead of describing a specific order or sequence. It should be understood that the terms used in such a way are interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and the character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The described technologies can be applied to both the systems and the radio technologies mentioned above as well as to other systems and radio technologies. The following descriptions describe a New Radio (NR) system for example purposes, and NR terms are used in most of the following descriptions, but these technologies can also be applied to an application other than an NR system application, for example, a 6^{th} Generation (6G) communication system.

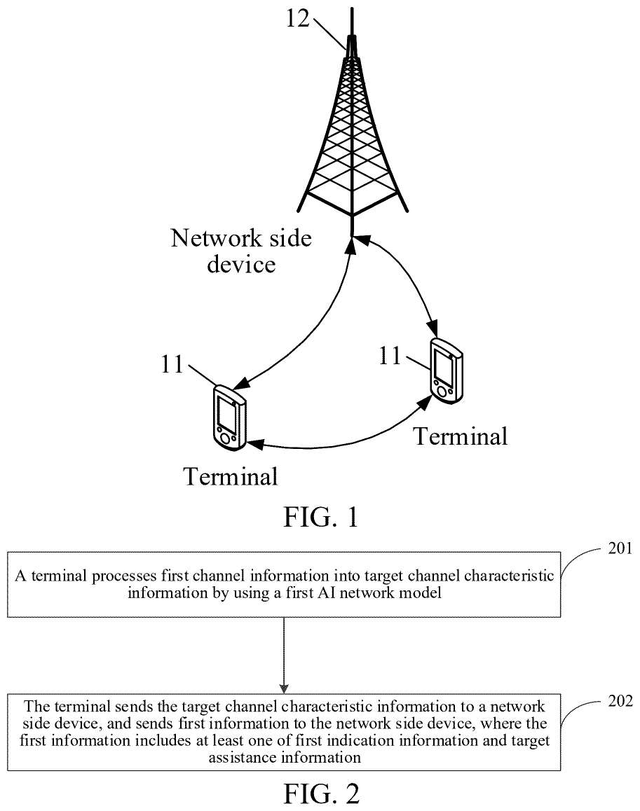

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), smart household (household devices with wireless communication functions, such as a refrigerator, a television, a washing machine, or furniture), a game console, a Personal Computer (PC), a teller machine, or a self-service machine, and the wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, and the like. It should be noted that, a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access node, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

In wireless communication technology, an accurate CSI feedback is very important for channel capacity. Especially for a multi-antenna system, a transmit end may optimize signal transmission based on CSI for better match with a state of the channel. For example, a Channel Quality Indicator (CQI) may be used to select an appropriate Modulation and Coding Scheme (MCS), to realize link adaptation; and a Precoding Matrix Indicator (PMI) may be used to realize eigen beamforming (eigen beamforming), to maximize a strength of a received signal, or to suppress interference (such as inter-cell interference, multi-user interference, and the like). Therefore, since a multi-antenna technology (such as: Multi-Input Multi-Output (MIMO)) is put forward, obtaining of CSI has always been a research hotspot.

Generally, the network side device sends CSI-Reference Signals (CSI-RS) on some time-frequency resources of a specific slot, and the terminal performs channel estimation based on the CSI-RS, calculates channel information on this slot, and feeds back a PMI to the base station through a codebook. The network side device combines channel information based on codebook information fed back by the terminal, and before the terminal reports CSI next time, the network side device uses the channel information for data precoding and multi-user scheduling.

To further reduce CSI feedback overheads, the terminal may change PMI reporting of each sub-band to PMI reporting based on a time delay (a delay domain, that is, a frequency domain). Because channels in the delay domain are more concentrated, PMIs of all sub-bands may be approximately represented with less delay PMIs. This may be regarded as compressing information in the delay domain before reporting.

Similarly, to reduce the overheads, the network side device may pre-code the CSI-RS in advance and send coded CSI-RS to the terminal. The terminal obtains a channel corresponding to the coded CSI-RS, and the terminal only needs to select several ports with higher strength from ports indicated by the network side device and report coefficients corresponding to the ports.

In related technology, a compression effect of channel characteristic information can be improved by using an AI network model to compress channel information, where an AI module has various implementations, such as a neural network, a decision tree, a support vector machine, and a Bayes classifier. For ease of description, in the embodiments of this application, an example in which the AI network model is the neural network is used for description, but this does not limit a specific type of the AI network model.

In the embodiments of this application, on a terminal, a first AI network model with a coding function (namely, an AI network model in a coder, which may also be referred to as a coder network model or a coding AI network model) is used to compress and code the channel information, and report coded channel characteristic information to the network side device (for example, a base station); and on a base station side, a third AI network model with a decoding function (namely, an AI network model in a decoder, which may also be referred to as a decoder network model or a decoded AI network model) is used to decode compressed channel characteristic information, to recover the channel information. In this case, the third AI network model of the base station and the first AI network model of the terminal need to be jointly trained, to achieve a proper matching degree. The neural network forms a joint neural network through the coder network model of the terminal and the decoder network model of the base station, and the joint neural network is jointly trained by the network side device. After the training is completed, the base station sends the coder network model to the terminal.

The terminal estimates a CSI Reference Signal (CSI-RS), and performs calculation based on estimated channel information, to obtain calculated channel information; and then, the calculated channel information or the original estimated channel information is coded by using a coding network model, to obtain a coded result (namely, channel characteristic information), and finally the coded result is sent to the base station. On the base station side, after receiving the coded result, the base station inputs the coded result into the decoding network model, and uses the decoding network model to recover the channel information.

However, in different channel environments, compressibility of channel information varies, so a length of coded channel information also varies, for example, simple channel information only needs a short coding length, but complex channel information needs longer coding information. In this way, weight parameters and even network structures of AI network models corresponding to different lengths of coding information are different, which requires retraining the AI network model matching the coding length.

It can be learned that in related technology, matching degrees of channel information in different lengths with a specific AI network model are different. In other words, with the change of channel quality, a matching degree between an AI network model and a channel state may decrease, resulting in reduced accuracy of a result obtained after the AI network model codes or decodes the channel characteristic information.

In the embodiments of this application, the terminal may determine a first AI network model matching a current channel state based on indication of the network side device, a detected channel state, or the like, use the first AI network model to process channel information into coding information (namely, target channel characteristic information) in a length corresponding to the first AI network model, and report all or part of the target channel characteristic information to the network side device. In addition, the terminal further reports first information to the network side device, to inform the network side device of accuracy of second channel information recovered based on the target channel characteristic information, or to indicate information that may be used to assist the network side device in determining the accuracy of the second channel information (for example, a representation parameter of the first channel information), or to report target assistance information that may be used to assist the network side device in recovering the second channel information based on the target channel characteristic information to the network side device.

In this way, the network side device may determine the accuracy of the second channel information based on the accuracy of the second channel information recovered based on the target channel characteristic information, or based on a correlation between the representation parameter of the first channel information reported by the terminal and a representation parameter of the second channel information recovered by the network side device, and determine, based on the accuracy of the second channel information, whether the third AI network model and the first AI network model need to be updated; and/or determine, based on reliability of the second channel information recovered by the network side device, whether to use the target assistance information to assist recovery of the second channel information or directly use the target assistance information to recover the second channel information, and the like, so that the accuracy of the result obtained after the AI network model codes or decodes the channel characteristic information can be improved.

It should be noted that, in an implementation, the terminal reports the target channel characteristic information to the network side device, which may be carrying the target channel characteristic information in a CSI report and reporting the target channel characteristic information to the network side device in a manner of CSI reporting, where the channel characteristic information may be PMI information. The target channel characteristic information may also be reported to the network side device in any other manner. For ease of description, in the embodiments of this application, an example in which the target channel characteristic information is reported in the manner of CSI reporting is used for description. This is not specifically limited herein.

The following describes in detail the method for assisting in reporting channel characteristic information, the method for restoring channel characteristic information, the apparatus for assisting in reporting channel characteristic information, and the apparatus for restoring channel characteristic information through some embodiments and application scenarios thereof with reference to the accompanying drawings.

Refer to FIG. 2, a method for assisting in reporting channel characteristic information provided in an embodiment of this application may be executed by a terminal, and the terminal may be any type of terminal 11 listed in FIG. 1 or a terminal in a terminal type other than those listed in the embodiment shown in FIG. 1. This is not specifically limited herein. As shown in FIG. 2, the method for assisting in reporting channel characteristic information may include the following steps.

Step 201: A terminal processes first channel information into target channel characteristic information by using a first AI network model.

In an implementation, the first AI network model may include various types of AI algorithm modules, such as a neural network, a decision tree, a support vector machine, and a Bayes classifier. This is not specifically limited herein. For ease of description, in the following embodiments, an example in which the AI network model is a neural network model is used for description. This is not specifically limited herein.

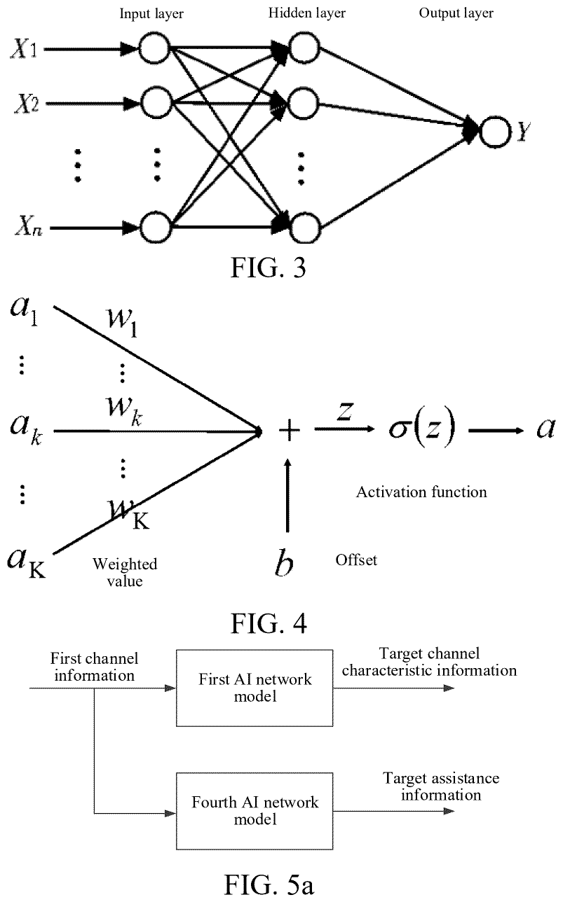

As shown in FIG. 3, the neural network model includes an input layer, a hidden layer, and an output layer. The neural network model may predict a possible output result (Y) based on input information (X₁-Xₙ) obtained by the input layer. The neural network model includes a large quantity of neurons, as shown in FIG. 4. Parameters of the neurons include: input parameters a₁-a_{K}, a weighted value w, an offset b, an activation function σ(z), and an output value a obtained with these parameters, where common activation functions include a sigmoid function, a tanh function, a Rectified Linear Unit (ReLU), which is also referred to as a rectified linear unit function, and the like, and z in the function σ(z) may be calculated by using the following formula:

$$z = {a}_{1} {w}_{1} + … + {a}_{k} {w}_{k} + {a}_{K} {w}_{K} + b ,$$

where
K represents a total quantity of input parameters.

Parameters of the neural network are optimized by using an optimization algorithm. The optimization algorithm is an algorithm that minimizes or maximizes an objective function (sometimes referred to as a loss function). The objective function is often a mathematical combination of a model parameter and data. For example, given data X and a corresponding label Y, a neural network model f (.) is constructed. After the neural network model is constructed, a predicted output f(x) can be obtained based on the input X, and a difference (f(x)−Y) between a predicted value and a real value can be calculated. This is the loss function. The purpose is to find appropriate W and b, so that a value of the loss function reaches a minimum. A smaller loss value indicates that the model is closer to a real situation.

Currently, common optimization algorithms are basically based on an error back propagation algorithm. A basic idea of the error back propagation algorithm is that a learning process includes two processes: signal forward propagation and error back propagation. During forward propagation, an input sample is transferred from an input layer to an output layer after being processed by each hidden layer. If an actual output of the output layer does not match an expected output, error back propagation is performed. Error back propagation is to transmit an output error layer by layer to the input layer through a hidden layer in some form for back propagation, and allocate the error to all units of each layer, to obtain an error signal of a unit at each layer. This error signal is used as a basis for correcting a weighted value of each unit. A weighted value adjustment process of each layer during signal forward propagation and error back propagation is carried out repeatedly. A process of continuously adjusting a weighted value is a learning and training process of a network. This process continues until errors output by the network are reduced to an acceptable level or until a preset quantity of learning times are reached.

Common optimization algorithms include Gradient Descent (GD), Stochastic Gradient Descent (SGD), mini-batch gradient descent, momentum, Nesterov (stochastic gradient descent with momentum), Adaptive Gradient Descent (Adagrad), adaptive learning rate adjustment (Adadelta), Root Mean Square prop (RMSprop), Adaptive Moment Estimation (Adam), and the like.

During error back propagation, in these optimization algorithms, an error/loss is obtained according to the loss function, a gradient is obtained by calculating a derivative/partial derivative of a current neuron, and adding an effect such as a learning rate and a previous gradient/derivative/partial derivative, and the gradient is transferred to an upper layer.

In an implementation, the first AI network model may be used to code channel information, and can code channel information in different channel environments into target channel characteristic information in corresponding lengths. A length of the target channel characteristic information may be a quantity of bits of the target channel characteristic information after quantization, or a quantity of coefficients included in the target channel characteristic information before quantization. For ease of description, in the embodiments of this application, an example in which the length of the channel characteristic information is a quantity of bits included in corresponding channel characteristic information after quantization is used for description. This is not specifically limited herein either.

In some embodiments, before the terminal processes first channel information into target channel characteristic information by using a first AI network model, the method further includes the following steps:

The terminal performs channel estimation on a Channel State Information-Reference Signal (CSI-RS) or a Tracking Reference Signal (TRS), to obtain the first channel information; or
the terminal preprocesses channel information obtained through channel estimation, to obtain the first channel information.

In this implementation, the first channel information obtained by using the first AI network model for coding processing may be channel information obtained by estimating a CSI-RS channel or a TRS channel by the terminal, or channel information obtained by preprocessing the estimated channel information by the terminal. This is not specifically limited herein.

Step 202. The terminal sends the target channel characteristic information to a network side device, and sends first information to the network side device, where the first information includes at least one of first indication information or target assistance information. The first indication information indicates accuracy of second channel information recovered based on the target channel characteristic information or indicates information for assisting the network side device in determining the accuracy of the second channel information, and the target assistance information is used to assist the network side device in recovering the second channel information based on the target channel characteristic information.

It should be noted that, in an implementation, the target channel characteristic information may be part of the channel characteristic information obtained by using the first AI network model. In this case, the target assistance information may be all of the channel characteristic information obtained by using the first AI network model or another part of the channel characteristic information obtained by using the first AI network model other than the target channel characteristic information. That is, it is assumed that the target channel characteristic information is a first length, a length of the target assistance information may be equal to a second length or equal to a difference between the second length and the first length, where the second length is a length of all of the channel characteristic information obtained after the first AI network model processes the first channel information.

### (First Aspect)

The first indication information may indicate accuracy of second channel information recovered based on the target channel characteristic information or indicate information for assisting the network side device in determining the accuracy of the second channel information, namely, indicate a correlation measure between the second channel information and the first channel information, or indicate a representation parameter of the first channel information. When the first indication information indicates the information for assisting the network side device in determining the accuracy of the second channel information, the information for assisting the network side device in determining the accuracy of the second channel information may be the representation parameter of the first channel information. For example, on a network side, the representation parameter of the second channel information may be calculated based on a recovery result of a decoder, and the correlation measure between the second channel information and the first channel information may be determined based on the correlation between the representation parameter of the second channel information and the representation parameter of the first channel information.

The first indication information may further indicate whether the accuracy meets a preset condition such as communication quality and service requirements. For ease of description, in the following embodiments, an example in which the first indication information indicates the accuracy of the second channel information recovered based on the target channel characteristic information or indicates the information for assisting the network side device in determining the accuracy of the second channel information is used for description. This is not specifically limited herein.

In an example implementation, the first indication information indicates at least one of the following:
a representation parameter of the first channel information;
a correlation measure between the first channel information and the second channel information; or
the correlation measure meets a preset condition, or the correlation measure does not meet the preset condition.

The representation parameter of the first channel information may be one parameter or at least two parameters of information content of the first channel information. In an implementation, the terminal may report the representation parameter of the first channel information when the second channel information is not obtained, and the network side device may calculate the representation parameter of the second channel information after recovering the second channel information based on the target channel characteristic information, and then determine the correlation measure between the first channel information and the second channel information based on the representation parameter of the first channel information and the representation parameter of the second channel information. In a case that the terminal obtains the second channel information, the correlation measure between the first channel information and the second channel information may be obtained on a terminal side, and the correlation measure is reported, or it is reported that the correlation measure meets or does not meet the preset condition. The representation parameter may be CQI, MCS, average delay spread, maximum Doppler frequency shift, correlation between ports, or the like.

The preset condition may be based on a protocol agreement and/or indicated by the network side device, or may be a correlation measure threshold determined by the terminal based on communication quality, service requirements, and the like in an actual communication scenario. In a case that the correlation measure between the first channel information and the second channel information meets the preset condition, it indicates that the current target channel characteristic information can meet channel quality requirements, so the coding AI network model does not need to be adjusted. For example, in a scenario with high communication quality requirements, it may be determined that the preset condition includes a high correlation measure threshold. Correspondingly, in a case that the correlation measure between the first channel information and the second channel information does not meet the preset condition, it indicates that the current target channel characteristic information cannot meet the channel quality requirements, so the coding AI network model needs to be adjusted to an AI network model with a longer coding length.

It should be noted that, in an implementation, based on different preset conditions, the following situations may also exist. In a case that the correlation measure between the first channel information and the second channel information meets the preset condition, it indicates that the current target channel characteristic information cannot meet the channel quality requirements, so the coding AI network model needs to be adjusted. However, in a case that the correlation measure between the first channel information and the second channel information does not meet the preset condition, it indicates that the current target channel characteristic information can meet the channel quality requirements, so the coding AI network model does not need to be adjusted. In actual application, it may be determined according to an actual situation of the preset condition specified by a protocol or indicated by the network side device. The first indication information is reported when the correlation measure between the first channel information and the second channel information meets the preset condition, or the first indication information is reported when the correlation measure between the first channel information and the second channel information does not meet the preset condition, so that the network side device determines, based on the received first indication information, whether to indicate the terminal to adjust the first AI network model. For ease of description, in the following embodiments, an example in which when the correlation measure between the first channel information and the second channel information meets the preset condition, it indicates that the current target channel characteristic information cannot meet the channel quality requirements, and when the correlation measure between the first channel information and the second channel information does not meet the preset condition, it indicates that the current target channel characteristic information can meet the channel quality requirements is used for description. This is not specifically limited herein.

In some embodiments, the correlation measure between the first channel information and the second channel information includes at least one of the following:
a correlation parameter of channel matrices corresponding to the first channel information and the second channel information respectively;
a correlation parameter obtained after the channel matrices corresponding to the first channel information and the second channel information respectively are mapped to a target transform domain, where the target transform domain includes at least one of an angle delay domain or a delay Doppler domain;
a power difference between equivalent channels corresponding to the first channel information and the second channel information respectively;
a difference between throughputs corresponding to the first channel information and the second channel information respectively;
a difference between CQIs corresponding to the first channel information and the second channel information respectively; or
a norm of a difference between the channel matrices corresponding to the first channel information and the second channel information respectively, for example, l norm, F norm, infinite norm, and the like.

Option 1: the correlation parameter of channel matrices corresponding to the first channel information and the second channel information respectively may be used as a variable to measure a correlation degree between the channel matrix corresponding to the first channel information and the channel matrix corresponding to the second channel information, for example, a Normalized Mean Squared Error (NMSE) of two matrices, and the like.

Option 2: similar to option 1, the correlation parameter obtained after the channel matrices corresponding to the first channel information and the second channel information respectively are mapped to the target transform domain may be a variable of a correlation degree after the channel matrices corresponding to the first channel information and the second channel information respectively are mapped to at least one of the angle delay domain or the delay Doppler domain.

In addition, the greater the value of at least one of the power difference between equivalent channels, the difference between throughputs, the difference between CQIs, the norm of the difference between the channel matrices, the smaller the correlation degree between the first channel information or the second channel information.

In an implementation, the correlation measure threshold may be an absolute threshold, that is, a correlation measure threshold with a fixed value. For example, the correlation measure threshold may be a relative threshold, for example, after receiving the first AI network model, the terminal uses a calculation result corresponding to target channel characteristic information fed back for the first time as the threshold, or uses a maximum value in calculation results corresponding to target channel characteristic information fed back in a period of time as the threshold.

The correlation measure threshold may also be a quantity of exceeding times relative to a target threshold, for example, a quantity of times that a CSI detection result is greater than or less than a specific threshold in a period of time exceeds a second threshold before performing a new behavior. For example, a coding and decoding network model on the base station side is adjusted only when a quantity of times that the CSI detection result is greater than a given threshold for more than 10 times in a period of time, otherwise the coding and decoding network model is not adjusted. This may reduce a probability of frequently adjusting the coding and decoding network model.

In some embodiments, indication information that the correlation measure meets the preset condition includes at least one of the following:
the correlation measure is in a preset quantitative relationship with a preset threshold, where the preset threshold is a preset constant, or the preset threshold includes a correlation measure value determined based on a feedback result of historical channel characteristic information; or
a quantity of times that the correlation measure is in the preset quantitative relationship with the preset threshold is less than a preset quantity of times;
and/or
indication information that the correlation measure does not meet the preset condition includes at least one of the following:
the correlation measure is in a non-preset quantitative relationship with a preset threshold, where the preset threshold is a preset constant, or the preset threshold includes a correlation measure value determined based on a feedback result of historical channel characteristic information; or
a quantity of times that the correlation measure is in the non-preset quantitative relationship with the preset threshold is greater than or equal to the preset quantity of times.

In an implementation, the terminal sends the first information to the network side device only when the correlation measure between the first channel information and the second channel information meets the preset condition, for example, when the correlation measure between the first channel information and the second channel information meets the preset condition, sending corresponding first information to the network side device, or starting to periodically send the first information to the network side device for a period of time. In other words, in a case that the correlation measure between the first channel information and the second channel information does not meet the preset condition, the terminal may not send the first information to the network side device, and the network side device may determine, based on that the first information is not received, that the correlation measure between the first channel information and the second channel information does not meet the preset condition. In this way, transmission overheads of the first information may be reduced.

In an implementation, the first indication information indicates the accuracy of the second channel information recovered based on the target channel characteristic information or indicates the information for assisting the network side device in determining the accuracy of the second channel information. Only when the terminal can obtain the second channel information recovered based on the target channel characteristic information, the first indication information may indicate the accuracy of the second channel information recovered based on the target channel characteristic information. Otherwise, the first indication information indicates the representation parameter of the first channel information, so that after obtaining the representation parameter of the first channel information, the network side device can match the representation parameter of the first channel information with the representation parameter of the second channel information recovered by the network side device, to determine a correlation between the representation parameters, where the greater the correlation between the representation parameters, the higher the accuracy of the second channel information.

In some embodiments, the method for assisting in reporting channel characteristic information further includes the following step:

The terminal obtains the second channel information by using at least one of the following manners:
recovering the second channel information by using a second AI network model based on the target channel characteristic information, where the second AI network model is related to a third AI network model used by the network side device, and the third AI network model is used to recover the second channel information based on the target channel characteristic information;
determining the second channel information based on a channel estimation result of a demodulation reference signal (DMRS) sent by the network side device; or
determining the second channel information based on a first reference signal obtained on at least some ports, where the first reference signal is a precoded reference signal, and precoding information of the first reference signal includes the second channel information recovered by the network side device by using the third AI network model based on the target channel characteristic information.

Option 1: in a case that the terminal recovers the second channel information by using a second AI network model based on the target channel characteristic information, where the second AI network model is related to a third AI network model used by the network side device, and the third AI network model is used to recover the second channel information based on the target channel characteristic information, the second AI network model may be a network model the same as the third AI network model, or the second AI network model may be a simplified model of the third AI network model. In this way, the terminal may use the second AI network model to simulate a process in which the network side device recovers the second channel information by using the third AI network model based on the target channel characteristic information, so that the terminal obtains, through simulation, a process in which the network side device recovers the target channel characteristic information, thereby obtaining the second channel information.

In this embodiment, the terminal needs to obtain the third AI network model or the simplified model of the third AI network model.

For example, the method for assisting in reporting channel characteristic information further includes the following steps:

The terminal receives related information of the third AI network model from the network side device.

The terminal determines the second AI network model based on the related information of the third AI network model.

The related information of the third AI network model may be a model parameter, a model configuration, identification information of a model, or the like. Based on the related information, the terminal can determine which third AI network model the network side device may use to decode the target channel characteristic information. Then, the terminal may use the third AI network model or the simplified network model of the third AI network model to simulate a process in which the network side device decodes the target channel characteristic information, to compare a simulated decoded result (namely, the second channel information) with the first channel information, to determine the correlation measure between them.

Further, based on a Signal-to-Noise Ratio (SNR) and the like in the current communication environment, the terminal may further add noise with specific power to the target channel information, and then input the target channel information with the noise into the second AI network model, to more closely simulate a process in which the network side device receives the target channel information and recovers the second channel information in the current communication environment.

Option 2: in a case that the terminal determines the second channel information based on the channel estimation result of a demodulation reference signal sent by the network side device, the DMRS may be a DMRS determined by the network side device based on the second channel information. In this way, the terminal may reversely deduce, based on channel estimation of the DMRS sent by the network side device, the second channel information recovered by the network side device.

Option 3: in a case that the terminal determines the second channel information based on the first reference signal obtained on at least some ports, where the first reference signal is a precoded reference signal, and precoding information of the first reference signal includes the second channel information recovered by the network side device by using the third AI network model based on the target channel characteristic information, after the network side device recovers the second channel information, the second channel information may be mapped to the first reference signal through precoding, where the first reference signal may be a Tracking Reference Signal (TRS), a CSI-RS, or another reference signal. In this way, when receiving the first reference signal, the terminal may decode the first reference signal correspondingly, to obtain the precoding information including the second channel information.

In this implementation, after obtaining the second channel information through any one or at least two of the above manners, the terminal may compare the second channel information with the first channel information, to determine the correlation measure between them, thereby generating the first indication information that indicates the correlation measure between the first channel information and the second channel information, or indicates whether the correlation measure meets the preset condition.

Correspondingly, in a case that the network side device obtains the first indication information, the accuracy of the second channel information may be obtained based on the first indication information, or when the first indication information indicates the information for assisting the network side device in determining the accuracy of the second channel information, the information for assisting the network side device in determining the accuracy of the second channel information may be the representation parameter of the first channel information. The network side device may determine the accuracy of the second channel information based on the correlation between the representation parameter of the recovered second channel information and the representation parameter of the first channel information. In this way, when it is determined that the accuracy of the second channel information cannot meet the preset conditions, the first AI network model and the third network model may be updated, or the terminal is indicated to report longer target channel characteristic information. For example, indicating the terminal to use a first AI network model with a longer coding length to process the first channel information, to obtain the longer target channel characteristic information, or in a case that the target channel characteristic information is part of the channel characteristic information obtained by using the first AI network model, the target assistance information is enabled to include all or another part of the channel characteristic information obtained by using the first AI network model, so that the target assistance information may be used to extend the length of the channel characteristic information obtained by the network side device.

For example, in a case that the first indication information indicates that the existing first AI network model is not enough to support CSI feedback accuracy, the base station may train the AI network model, to obtain a first AI network model with a longer output length and a third AI network model with a longer input length, and send the newly trained first AI network model or the newly trained first AI network model and the newly trained third AI network model to the terminal, so that the base station and the terminal use the updated first AI network model and the updated third AI network model to code and recover the channel characteristic information after completing AI network model updating. It should be noted that, after the base station obtains the first indication information indicating that the existing first AI network model is not enough to support the CSI feedback accuracy, and before the base station and the terminal complete AI network model updating, the base station may further adjust a CQI used during scheduling, reduce a MCS, reduce a quantity of scheduling layers, or perform other operations, and then perform normal operations until the base station and the terminal complete AI network model updating.

It should be noted that, in a case that the first indication information indicates that the existing first AI network model is not enough to support the CSI feedback accuracy, the base station may directly fit the received channel characteristic information without adjusting the first AI network model and the third AI network model, or compensate the calculated CQI, MCS, and the like. This is not specifically limited herein.

### (Second Aspect)

In an implementation, the target assistance information may be information determined by the terminal based on a channel state of a target channel corresponding to the first channel information.

In some embodiments, before the terminal sends first information to the network side device, the method further includes the following step:

The terminal determines the target assistance information by using a fourth AI network model based on second information, where the second information includes at least one of the following:
the first channel information; or
the target channel characteristic information.

In an implementation, the fourth AI network model may also be referred to as an assistance network model, may use at least one of the first channel information or the target channel characteristic information as an input, and outputs the target assistance information. In an implementation, the assistance network model may be obtained through joint training with a codec network model (that is, a joint network model including the first AI network model and the third AI network model).

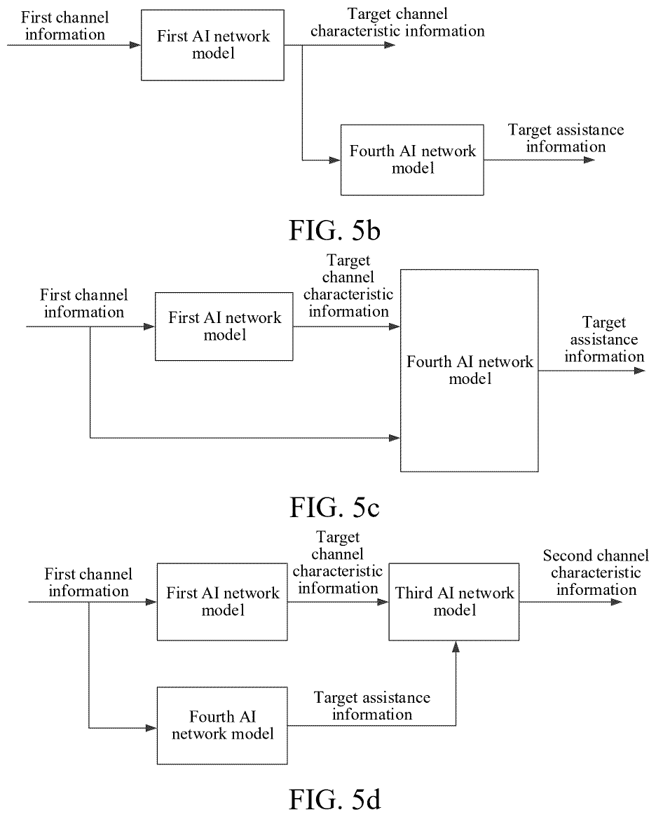

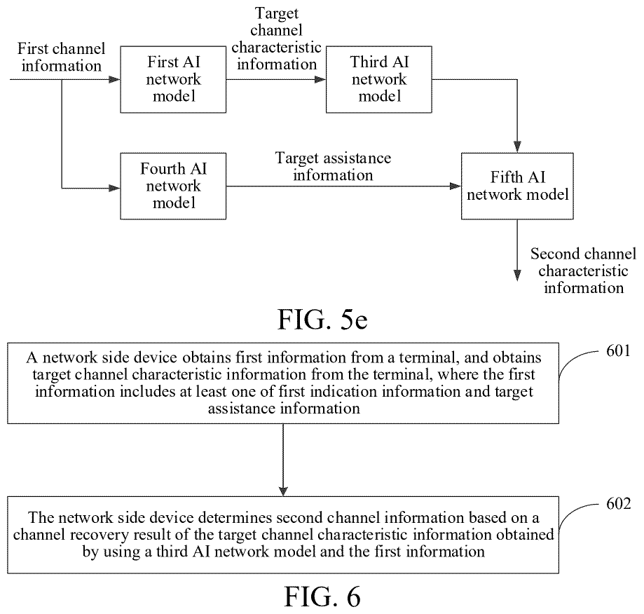

For example, as shown in FIG. 5a, both an input of the first AI network model and an input of the fourth AI network model include the first channel information, but output results of the two models are the target channel characteristic information and the target assistance information respectively, for example, the fourth AI network model is a coding network model with a long coding length, while the first AI network model is a coding network model with a short coding length.

For another example, as shown in FIG. 5b, any input of the first AI network model includes the first channel information, and an output result is the target channel characteristic information, while any input of the fourth AI network model includes the target channel characteristic information, and an output result is the target assistance information.

For another example, as shown in FIG. 5c, any input of the first AI network model includes the first channel information, and an output result is the target channel characteristic information, while any input of the fourth AI network model includes the target channel characteristic information and the first channel information, and an output result is the target assistance information.

In this implementation, the fourth AI network model may be used to determine the target assistance information based on at least one of the first channel information or the target channel characteristic information. This may simplify a determination process of the target assistance information.

In an implementation, the target assistance information is used to assist the network side device in recovering the second channel information based on the target channel characteristic information, where both the target assistance information and the target channel characteristic information may be used as inputs of the third AI network model, to obtain the second channel information that is output by the third AI network model; or after the target channel characteristic information is used as an input of the third AI network model to obtain channel information that is output by the third AI network model, the target assistance information is used to correct or supplement the channel information that is output by the third AI network model, to obtain the second channel information; or at least one of parameters such as a parameter, a structure, or a weighted value of the third AI network model is adjusted based on the target assistance information, and the target channel characteristic information is used as an input of the adjusted third AI network model, to obtain second channel information that is output by the adjusted third AI network model.

In a first possible implementation, the target assistance information is used to assist the network side device in recovering the second channel information based on the target channel characteristic information. The target assistance information may be input as a part of the third AI network model, so that the third AI network model recovers the second channel information based on the target assistance information and the target channel characteristic information. In other words, in this implementation, the decoder has two inputs, one is a coded result of the coder (that is, the target channel characteristic information), and the other is the target assistance information. In addition, when that terminal does not report the target assistance information, the coder may use a default value to replace an input item corresponding to the target assistance information.

For example, as shown in FIG. 5d, the third AI network model includes two input items, one is the target channel characteristic information that is output by the first AI network model, and the other is the target assistance information that is output by the fourth AI network model.

In a second possible implementation, the target assistance information is used to assist the network side device in recovering the second channel information based on the target channel characteristic information. After the third AI network model recovers specific channel information based on the target channel characteristic information, the channel information and the target assistance information may be input into another assistance recovery AI network model (namely, a fifth AI network model), so that the assistance recovery AI network model corrects or supplements, based on the target assistance information, channel information that is output by the third AI network model, to obtain second channel information with higher accuracy.

For example, as shown in FIG. 5e, a fifth AI network model is further set at an output end of the third AI network model. The fifth AI network model includes two input items, one is the channel information that is output by the third AI network model, and the other is the target assistance information that is output by the fourth AI network model.

In an implementation, the fourth AI network model and the fifth AI network model may be AI network models jointly trained by the network side device, for example, an assistance recovery network (namely, a joint network model including the fourth AI network model and the fifth AI network model) is trained independently of the codec (namely, a joint network model including the first AI network model and the third AI network model), that is, an input and an output of the codec are used as a joint input to train the fourth AI network model and the fifth AI network model. In some embodiments, a corresponding assistance recovery network may be trained for each trained codec, that is, the codec is in a one-to-one correspondence with the assistance recovery network, or the assistance recovery network is trained based on inputs and outputs of all codecs, that is, all codecs correspond to a same assistance recovery network.

In actual application, the assistance recovery network and the codec may also be obtained through joint training. This is not specifically limited herein.

In a third possible implementation, that the target assistance information is used to assist the network side device in recovering the second channel information based on the target channel characteristic information may be: the network side device modifies at least one of a parameter, a weight, or even a structure of the third AI network model based on the target assistance information, and uses the modified third AI network model to recover the second channel information based on the target channel characteristic information. In this way, a parameter and/or structure of the decoder may be directly optimized without replacing the coder, so that an output result of the decoder is more consistent with an actual value.

Similar to the third possible implementation, the network side device may further modify at least one of the parameter, the weight, or even the structure of the first AI network model based on the target assistance information, and send the modified first AI network model to the terminal, so that the terminal can obtain more accurate target channel characteristic information by processing the first channel information by using the modified first AI network model.

In some embodiments, the target channel characteristic information includes channel characteristic information in a first length, the target assistance information includes channel characteristic information in a second length or a part in the channel characteristic information in the second length other than the channel characteristic information in the first length, and the second length is greater than the first length.

In an implementation, the first length may be a quantity of bits of the target channel characteristic information or a quantity of coefficients included in the target channel characteristic information; and/or
the second length may be a length of channel characteristic information obtained after the first AI network model processes the first channel information.

For example, it is assumed that the first AI network model outputs 100-bit PMI information (that is, the target channel characteristic information), when the target assistance information needs to be fed back, an AI network model that outputs 200-bit PMI information may be used, and the 200-bit information is used as PMI feedback. In this case, the assistance information is richer PMI information; or first 100 bits of the 200 bits are used as the target channel characteristic information, and last 100 bits are used as the target assistance information; or 100 bits in a specific position of the 200 bits are used as the target channel characteristic information, and 100 bits in another position are used as the target assistance information.

In this implementation, the target channel characteristic information is only a part of the coded result that is output by the first AI network model, and the target assistance information may be all of the coded result that is output by the first AI network model or another part other than the target channel characteristic information. In an implementation, the terminal may not report the target assistance information when the correlation measure between the first channel information and the second channel information meets the preset conditions. In this way, when the network side device can recover, based on a part of the coded result, channel information meeting a channel condition, an amount of reported channel characteristic information may be reduced, thereby reducing reporting overheads.

Further, the target channel characteristic information is obtained by the terminal processing the first channel information by using the fourth AI network model; and/or
the target channel characteristic information includes part of the channel characteristic information obtained after the first AI network model processes the first channel information, and the target assistance information includes all of the channel characteristic information obtained after the first AI network model processes the first channel information or part of the channel characteristic information other than the target channel characteristic information.

Option 1: in a case that the target channel characteristic information is obtained by the terminal processing the first channel information by using the fourth AI network model, the first AI network model and the fourth AI network model may be the same type of coding network model, but a length of a coded result that is output by the fourth AI network model is greater than that of the first AI network model. The terminal may use two independent coding network models to generate the target channel characteristic information and the target assistance information.

Option 2: the target channel characteristic information includes part of the channel characteristic information obtained after the first AI network model processes the first channel information, and the target assistance information includes all of the channel characteristic information obtained after the first AI network model processes the first channel information or part of the channel characteristic information other than the target channel characteristic information. The terminal may use a coding network model to generate one piece of complete piece of channel characteristic information, and the target assistance information may be a longer part or all of the complete piece of channel characteristic information, while the target channel characteristic information is a shorter part of the complete piece of channel characteristic information.

In an example implementation, the method for assisting in reporting channel characteristic information further includes the following step:

The terminal receives first configuration information, where the first configuration information is used to configure a target uplink resource.

That the terminal sends first information to the network side device includes: the terminal sends the first information to the network side device by using the target uplink resource.

In this implementation, the network side device may configure a reporting resource for the first information in advance.

In an example implementation, the method for assisting in reporting channel characteristic information further includes:

The terminal receives second configuration information, where the second configuration information carries target period information.

That the terminal sends first information to the network side device includes:

The terminal periodically sends the first information to the network side device based on the target period information.

In this implementation, the network side device may configure a reporting period for the first information, so that the terminal reports the first information periodically.

In an example implementation, that the terminal sends first information to the network side device includes:

The terminal sends the first information to the network side device in a case of receiving second indication information, where the second indication information is used to trigger reporting of the first information, where
the second indication information may be carried in a Medium Access Control (MAC) Control Element (CE) or Downlink Control Information (DCI).

In this implementation, in a case of receiving the second indication information, the terminal is triggered to send the first information to the network side device. In an implementation, the trigger may be triggering reporting once, that is, when receiving the second indication information, the terminal sends the first information to the network side device once. The trigger may also be triggering the terminal to report the first information continuously or periodically, that is, after the terminal receives the second indication information, the terminal may send the first information to the network side device for many times until the network side device cancels reporting of the first information by the terminal.

In some embodiments, the first information and the target channel characteristic information are carried in a same CSI report.

In an implementation, the network side device may configure the CSI report to carry the first information and the target channel characteristic information, so that reporting of the first information may be started by default, and reporting of the first information does not need to be triggered by using the second indication information or in other manners.

In the embodiments of this application, the terminal may determine a first AI network model matching a current channel state based on indication of the network side device, a detected channel state, or the like, use the first AI network model to process channel information into coding information (namely, target channel characteristic information) in a length corresponding to the first AI network model, and report all or part of the target channel characteristic information to the network side device. In addition, the terminal further reports first information to the network side device, to inform the network side device of accuracy of second channel information recovered based on the target channel characteristic information, or to indicate information that is used to assist the network side device in determining the accuracy of the second channel information, or to report target assistance information that may be used to assist the network side device in recovering the second channel information based on the target channel characteristic information to the network side device. In this way, the network side device may determine, based on the accuracy of the second channel information recovered based on the target channel characteristic information or the accuracy of the first channel information, whether the third AI network model and the first AI network model need to be updated; and/or determine, based on reliability of the second channel information recovered by the network side device, whether to use the target assistance information to assist recovery of the second channel information, so that the accuracy of the result obtained after the AI network model codes or decodes the channel characteristic information can be improved.

Refer to FIG. 6, a method for restoring channel characteristic information provided in an embodiment of this application may be executed by a network side device, and the terminal may be any type of network side device 12 listed in FIG. 1 or a network side device in a network side device type other than those listed in the embodiment shown in FIG. 1. This is not specifically limited herein. As shown in FIG. 6, the method for restoring channel characteristic information may include the following steps.

Step 601: A network side device obtains first information from a terminal, and obtains target channel characteristic information from the terminal, where the first information includes at least one of first indication information or target assistance information, the first indication information indicates accuracy of second channel information recovered based on the target channel characteristic information or indicates information for assisting the network side device in determining the accuracy of the second channel information, and the target assistance information is used to assist the network side device in recovering the second channel information based on the target channel characteristic information.

Step 602: The network side device determines the second channel information based on a channel recovery result of the target channel characteristic information obtained by using a third AI network model and the first information.

In an implementation, the first information, the target channel characteristic information, and the second channel information have the same meanings as the first information, the target channel characteristic information, and the second channel information in the method embodiment shown in FIG. 2. Details are not described herein again.

In some embodiments, that the network side device determines the second channel information based on a channel recovery result of the target channel characteristic information obtained by using a third AI network model and the first information includes:
the network side device determines, based on the first information, whether to update the third AI network model; and
in a case that the network side device determines to update the third AI network model, restores the second channel information by using the updated third AI network model based on the target channel characteristic information.

The method for restoring channel characteristic information further includes the following steps:

The network side device sends a related parameter of the updated first AI network model to the terminal, or sends the related parameter of the updated first AI network model and a related parameter of the updated third AI network model to the terminal, where the updated first AI network model is associated with the updated third AI network model.

Optionally, that the network side device determines the second channel information based on a channel recovery result of the target channel characteristic information obtained by using a third AI network model and the first information includes:
the network side device restores third channel information by using the third AI network model based on the first information and/or the target channel characteristic information, and processes the target assistance information and the third channel information by using a fifth AI network model, to obtain the second channel information;
or
the network side device processes the target channel characteristic information into third information by using the third AI network model, and restores the second channel information by using the fifth AI network model based on the target assistance information and the third information.

In an implementation, the network side device may further adjust at least one of a parameter, a structure, or a weighted value of the third AI network model based on the target assistance information, and uses the adjusted third AI network model to recover the second channel information based on the target channel characteristic information.

In some embodiments, the first indication information indicates at least one of the following:
a representation parameter of the first channel information;
a correlation measure between the first channel information and the second channel information, where target CSI is obtained by the terminal processing the first channel information by using the first AI network model; or
the correlation measure meets a preset condition, or the correlation measure does not meet the preset condition.

In some embodiments, the method for restoring channel characteristic information further includes:
the network side device sends related information of the third AI network model to the terminal, where the terminal recovers the second channel information by using a second AI network model based on the target channel characteristic information, and the second AI network model corresponds to the third AI network model; and/or
the network side device determines a demodulation reference signal based on the second channel information, and sends the DMRS to the terminal; and/or
the network side device precodes a first reference signal based on the second channel information, and sends the precoded first reference signal to the terminal.

In some embodiments, the target channel characteristic information includes channel characteristic information in a first length, the target assistance information includes channel characteristic information in a second length or a part in the channel characteristic information in the second length other than the channel characteristic information in the first length, and the second length is greater than the first length.

In some embodiments, the first length is a quantity of bits of the target channel characteristic information or a quantity of coefficients included in the target channel characteristic information; and/or
the second length is a length of channel characteristic information obtained after the first AI network model processes the first channel information, and the target channel characteristic information is part of the channel characteristic information obtained after the first AI network model processes the first channel information.

In some embodiments, the method for restoring channel characteristic information further includes the following step:

The network side device sends first configuration information to the terminal, where the first configuration information is used to configure a target uplink resource.

That a network side device obtains first information from a terminal includes: the network side device obtains the first information from the terminal by using the target uplink resource.

In some embodiments, the method for restoring channel characteristic information further includes the following step:

The network side device sends second configuration information to the terminal, where the second configuration information carries target period information.

That a network side device obtains first information from a terminal includes: the network side device periodically obtains the first information from the terminal based on the target period information.

In some embodiments, the method for restoring channel characteristic information further includes the following step:

The network side device sends second indication information to the terminal, where the second indication information is used to trigger the terminal to report the first information.

In some embodiments, the first information and the target channel characteristic information are carried in a same CSI report.

In this embodiment of this application, the network side device can determine, based on the first indication information reported by the terminal, whether to deliver a new codec network model, so that the terminal and the network side device can use the newly delivered codec network model to improve accuracy of a codec result of the first channel information, and/or the network side device can improve, based on the target assistance information reported by the terminal, accuracy of the recovered second channel information.

To facilitate description of the method for assisting in reporting channel characteristic information and the method for restoring channel characteristic information provided in the embodiments of this application, an embodiment of this application illustrates the method for assisting in reporting channel characteristic information and the method for restoring channel characteristic information provided in the embodiments of this application by using the following interactive process of the channel characteristic information as an example. In this embodiment, the interactive process of the channel characteristic information includes the following steps.

Step 1: A terminal detects a CSI-RS or TRS at a time-frequency domain location designated by a network, and performs channel estimation, to obtain first channel information.

Step 2: The terminal codes the first channel information into target channel characteristic information by using a first AI network model (namely, an AI coding network model).

Step 3: The terminal combines part or all of the target channel characteristic information, the first information, and other control information into Uplink Control Information (UCI), or uses part or all of the target channel characteristic information as the UCI.

Step 4: The terminal divides the UCI based on a length of the UCI, and adds a Cyclic Redundancy Check (CRC) bit.

Step 5: The terminal performs channel coding on UCI to which the CRC bit is added.

Step 6: The terminal performs rate matching on the UCI.

Step 7: The terminal performs code block association on the UCI.

Step 8: The terminal maps the UCI to a Physical Uplink Control Channel (PUCCH) or a Physical Uplink Shared Channel (PUSCH) for reporting.

It should be noted that, in the interactive process of the channel characteristic information, orders of some steps may be adjusted or omitted. This is not specifically limited herein.

The method for assisting in reporting channel characteristic information provided in this embodiment of this application may be executed by an apparatus for assisting in reporting channel characteristic information. In this embodiment of this application, that the apparatus for assisting in reporting channel characteristic information performs the method for assisting in reporting channel characteristic information is used as an example to describe the apparatus for assisting in reporting channel characteristic information provided in the embodiments of this application.

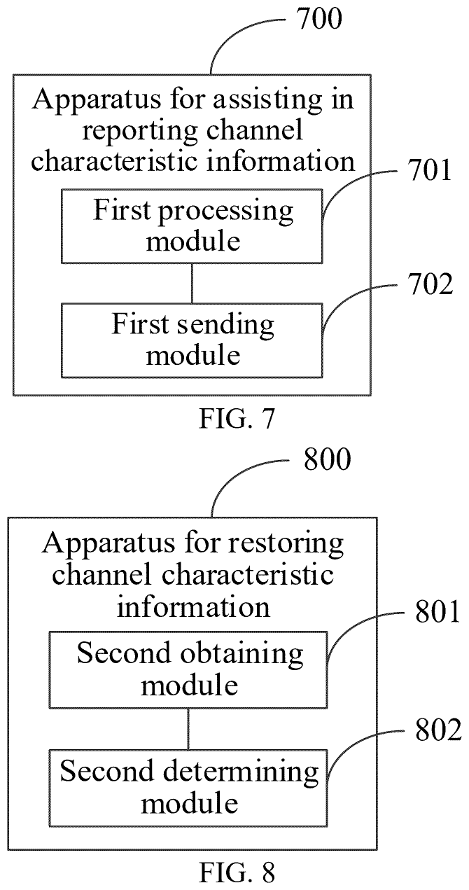

Refer to FIG. 7, an apparatus for assisting in reporting channel characteristic information provided in an embodiment of this application may be an apparatus in the terminal. As shown in FIG. 7, the apparatus 700 for assisting in reporting channel characteristic information may include the following modules:
a first processing module 701, configured to process first channel information into target channel characteristic information by using a first AI network model; and
a first sending module 702, configured to: send the target channel characteristic information to a network side device, and send first information to the network side device, where the first information includes at least one of first indication information or target assistance information, where
the first indication information indicates accuracy of second channel information recovered based on the target channel characteristic information or indicates information for assisting the network side device in determining the accuracy of the second channel information, and the target assistance information is used to assist the network side device in recovering the second channel information based on the target channel characteristic information.

In some embodiments, the first indication information indicates at least one of the following:
a representation parameter of the first channel information;
a correlation measure between the first channel information and the second channel information; or
the correlation measure meets a preset condition, or the correlation measure does not meet the preset condition.

In some embodiments, the apparatus 700 for assisting in reporting channel characteristic information further includes:
a first obtaining module, configured to obtain the second channel information by using at least one of the following manners:
recovering the second channel information by using a second AI network model based on the target channel characteristic information, where the second AI network model is related to a third AI network model used by the network side device, and the third AI network model is used to recover the second channel information based on the target channel characteristic information;
determining the second channel information based on a channel estimation result of a demodulation reference signal sent by the network side device; or
determining the second channel information based on a first reference signal obtained on at least some ports, where the first reference signal is a precoded reference signal, and precoding information of the first reference signal includes the second channel information recovered by the network side device by using the third AI network model based on the target channel characteristic information.

In some embodiments, the apparatus 700 for assisting in reporting channel characteristic information further includes:
a first receiving module, configured to receive related information of the third AI network model from the network side device; and
a third determining module, configured to determine the second AI network model based on the related information of the third AI network model.

In some embodiments, the correlation measure between the first channel information and the second channel information includes at least one of the following:
a correlation parameter of channel matrices corresponding to the first channel information and the second channel information respectively;
a correlation parameter obtained after the channel matrices corresponding to the first channel information and the second channel information respectively are mapped to a target transform domain, where the target transform domain includes at least one of an angle delay domain and a delay Doppler domain;
a power difference between equivalent channels corresponding to the first channel information and the second channel information respectively;
a difference between throughputs corresponding to the first channel information and the second channel information respectively;
a difference between CQI corresponding to the first channel information and the second channel information respectively; or
a norm of a difference between the channel matrices corresponding to the first channel information and the second channel information respectively.

In some embodiments, indication information that the correlation measure meets the preset condition includes at least one of the following:
the correlation measure is in a preset quantitative relationship with a preset threshold, where the preset threshold is a preset constant, or the preset threshold includes a correlation measure value determined based on a feedback result of historical channel characteristic information; or
a quantity of times that the correlation measure is in the preset quantitative relationship with the preset threshold is less than a preset quantity of times; and/or
indication information that the correlation measure does not meet the preset condition includes at least one of the following:
the correlation measure is in a non-preset quantitative relationship with a preset threshold, where the preset threshold is a preset constant, or the preset threshold includes a correlation measure value determined based on a feedback result of historical channel characteristic information; or
a quantity of times that the correlation measure is in the non-preset quantitative relationship with the preset threshold is greater than or equal to the preset quantity of times.

In some embodiments, that the terminal sends first information to the network side device includes:
the terminal sends the first information to the network side device in a case that the correlation measure between the first channel information and the second channel information meets the preset condition.

In some embodiments, the apparatus 700 for assisting in reporting channel characteristic information further includes:
a first determining module, configured to determine the target assistance information by using a fourth AI network model based on second information, where the second information includes at least one of the following:
the first channel information; or
the target channel characteristic information.

In some embodiments, the target channel characteristic information includes channel characteristic information in a first length, the target assistance information includes channel characteristic information in a second length or a part in the channel characteristic information in the second length other than the channel characteristic information in the first length, and the second length is greater than the first length.

In some embodiments, the first length is a quantity of bits of the target channel characteristic information or a quantity of coefficients included in the target channel characteristic information; and/or
the second length is a length of channel characteristic information obtained after the first AI network model processes the first channel information.

In some embodiments, the target channel characteristic information is obtained by the terminal processing the first channel information by using the fourth AI network model; and/or
the target channel characteristic information includes part of the channel characteristic information obtained after the first AI network model processes the first channel information, and the target assistance information includes all of the channel characteristic information obtained after the first AI network model processes the first channel information or part of the channel characteristic information other than the target channel characteristic information.

In some embodiments, the apparatus 700 for assisting in reporting channel characteristic information further includes:
a second receiving module, configured to receive first configuration information, where the first configuration information is used to configure a target uplink resource; and
the first sending module 702 is configured to:
send the first information to the network side device by using the target uplink resource.

In some embodiments, the apparatus 700 for assisting in reporting channel characteristic information further includes:
a third receiving module, configured to receive second configuration information, where the second configuration information carries target period information; and
the first sending module 702 is configured to:
periodically send the first information to the network side device based on the target period information.

In some embodiments, the first sending module 702 is configured to:
send the first information to the network side device in a case that the terminal receives second indication information, where the second indication information is used to trigger reporting of the first information.

In some embodiments, the first information and the target channel characteristic information are carried in a same CSI report.

The apparatus 700 for assisting in reporting channel characteristic information in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, a Network Attached Storage (NAS), and the like. This is not specifically limited in this embodiment of this application.

The apparatus 700 for assisting in reporting channel characteristic information provided in this embodiment of this application can implement the processes implemented in the method embodiment shown in FIG. 2, and a same technical effect is achieved. To avoid repetition, details are not described herein again.

The method for restoring channel characteristic information provided in this embodiment of this application may be executed by an apparatus for restoring channel characteristic information. In this embodiment of this application, that the apparatus for restoring channel characteristic information performs the method for restoring channel characteristic information is used as an example to describe the apparatus for restoring channel characteristic information provided in the embodiments of this application.

Refer to FIG. 8, an apparatus for restoring channel characteristic information provided in an embodiment of this application may be an apparatus in the network side device. As shown in FIG. 8, the apparatus 800 for restoring channel characteristic information may include the following modules:
a second obtaining module 801, configured to: obtain first information from a terminal, and obtain target channel characteristic information from the terminal, where the first information includes at least one of first indication information or target assistance information, the first indication information indicates accuracy of second channel information recovered based on the target channel characteristic information or indicates information for assisting the network side device in determining the accuracy of the second channel information, and the target assistance information is used to assist the network side device in recovering the second channel information based on the target channel characteristic information; and
a second determining module 802, configured to determine the second channel information based on a channel recovery result of the target channel characteristic information obtained by using a third AI network model and the first information.

In some embodiments, the second determining module 802 includes:
a first determining unit, configured to determine, based on the first information, whether to update the third AI network model; and
a second processing module, configured to restore, in a case that the network side device determines to update the third AI network model, the second channel information by using the updated third AI network model based on the target channel characteristic information.

The apparatus further includes:
a second sending module, configured to: send a related parameter of the updated first AI network model to the terminal, or send the related parameter of the updated first AI network model and a related parameter of the updated third AI network model to the terminal, where the updated first AI network model is associated with the updated third AI network model.

In some embodiments, the second determining module 802 is configured to:
restore third channel information by using the third AI network model based on the first information and/or the target channel characteristic information, and process the target assistance information and the third channel information by using a fifth AI network model, to obtain the second channel information;
or
process the target channel characteristic information into third information by using the third AI network model, and restore the second channel information by using the fifth AI network model based on the target assistance information and the third information.

In some embodiments, the first indication information indicates at least one of the following:
a representation parameter of the first channel information;
a correlation measure between the first channel information and the second channel information, where target CSI is obtained by the terminal processing the first channel information by using the first AI network model; or
the correlation measure meets a preset condition, or the correlation measure does not meet the preset condition.

In some embodiments, the apparatus 800 for restoring channel characteristic information further includes:
a third sending module, configured to send related information of the third AI network model to the terminal, where the terminal recovers the second channel information by using a second AI network model based on the target channel characteristic information, and the second AI network model corresponds to the third AI network model; and/or
a fourth sending module, configured to: determine a demodulation reference signal based on the second channel information, and send the DMRS to the terminal; and/or
a fifth sending module, configured to: precode a first reference signal based on the second channel information, and send the precoded first reference signal to the terminal.

In some embodiments, the target channel characteristic information includes channel characteristic information in a first length, the target assistance information includes channel characteristic information in a second length or a part in the channel characteristic information in the second length other than the channel characteristic information in the first length, and the second length is greater than the first length.

In some embodiments, the first length is a quantity of bits of the target channel characteristic information or a quantity of coefficients included in the target channel characteristic information; and/or
the second length is a length of channel characteristic information obtained after the first AI network model processes the first channel information, and the target channel characteristic information is part of the channel characteristic information obtained after the first AI network model processes the first channel information.

In some embodiments, the apparatus 800 for restoring channel characteristic information further includes:
a sixth sending module, configured to send first configuration information to the terminal, where the first configuration information is used to configure a target uplink resource; and
the second obtaining module 801 is configured to:
obtain the first information from the terminal by using the target uplink resource.

In some embodiments, the apparatus 800 for restoring channel characteristic information further includes:
a seventh sending module, configured to send second configuration information to the terminal, where the second configuration information carries target period information; and
the second obtaining module 801 is configured to:
periodically obtain the first information from the terminal based on the target period information.

In some embodiments, the apparatus 800 for restoring channel characteristic information further includes:
an eighth sending module, configured to send second indication information to the terminal, where the second indication information is used to trigger the terminal to report the first information.

The apparatus 800 for restoring channel characteristic information in this embodiment of this application may be an electronic device, for example, an electronic device with an operating system, or may be a component in the electronic device, for example, an integrated circuit or a chip. The electronic device may be a network side device, or another device other than the network side device. For example, the terminal may include but is not limited to the foregoing listed types of the network side device 12. The another device may be a server, a NAS, and the like. This is not specifically limited in this embodiment of this application.

The apparatus 800 for restoring channel characteristic information provided in this embodiment of this application can implement the processes implemented in the method embodiment shown in FIG. 6, and a same technical effect is achieved. To avoid repetition, details are not described herein again.

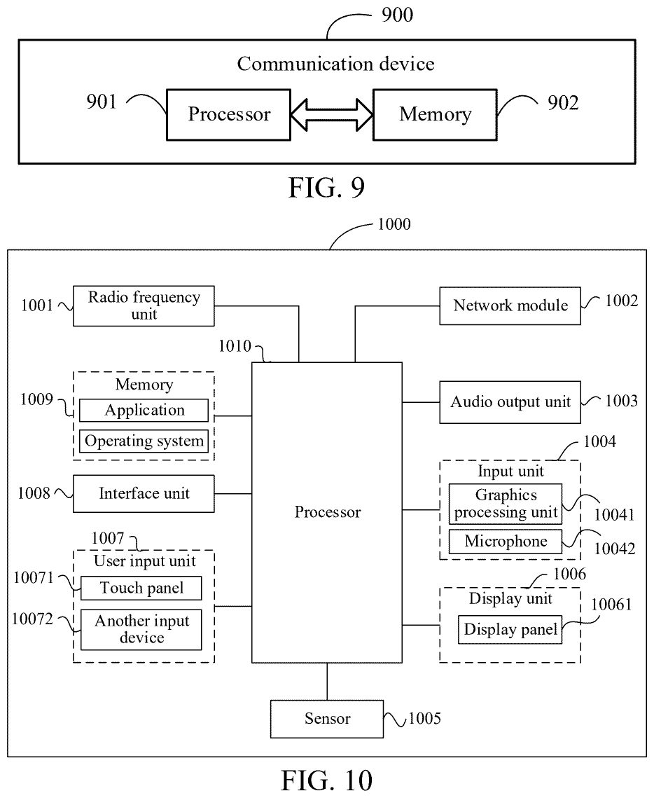

In some embodiments, as shown in FIG. 9, an embodiment of this application further provides a communication device 900, including a processor 901 and a memory 902. The memory 902 stores a program or an instruction that can be run on the processor 901. For example, when the communication device 900 is a terminal, the program or the instruction is executed by the processor 901 to implement the steps of the embodiment of the method for assisting in reporting channel characteristic information, and a same technical effect can be achieved. In a case that the communication device 900 is a network side device, when the program or the instruction is executed by the processor 901, the steps of the embodiment of the method for restoring channel characteristic information are implemented, and a same technical effect can be achieved. To avoid repetition, details are not described herein again.

An embodiment of this application further provides a terminal, including a processor and a communication interface. The processor is configured to process first channel information into target channel characteristic information by using a first AI network model; and the communication interface is configured to: send the target channel characteristic information to a network side device, and send first information to the network side device, where the first information includes at least one of first indication information or target assistance information, where the first indication information indicates accuracy of second channel information recovered based on the target channel characteristic information or indicates information for assisting the network side device in determining the accuracy of the second channel information, and the target assistance information is used to assist the network side device in recovering the second channel information based on the target channel characteristic information.

The terminal embodiment is corresponding to the terminal side method embodiment, each implementation process and implementation of the method embodiment may be applied to the terminal embodiment, and a same technical effect can be achieved. In some embodiments, FIG. 10 is a schematic diagram of a hardware structure of a terminal according to an embodiment of this application.

The terminal 1000 includes but is not limited to: at least some of the following components: a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The terminal structure shown in FIG. 10 constitutes no limitation on the terminal, and the terminal may include more or fewer components than those shown in the figure, or combine some components, or have different component arrangements. Details are not described herein again.

It should be understood that in this embodiment of this application, the input unit 1004 may include a Graphics Processing Unit (GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 or another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein again.

In this embodiment of this application, after receiving downlink data from a network side device, the radio frequency unit 1001 may transmit the downlink data to the processor 1010 for processing. In addition, the radio frequency unit 1001 may send uplink data to the network side device. Generally, the radio frequency unit 1001 includes but is not limited to an antenna, an amplifier, a transceiver, a coupler, a low noise amplifier, a duplexer, and the like.

The memory 1009 may be configured to store a software program or an instruction and various data. The memory 1009 may mainly include a first storage area for storing a program or an instruction and a second storage area for storing data. The first storage area may store an operating system, and an application or an instruction required by at least one function (for example, a sound playing function or an image playing function). In addition, the memory 1009 may be a volatile memory or a non-volatile memory, or the memory 1009 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1009 in this embodiment of this application includes but is not limited to these memories and any memory of another proper type.

The processor 1010 may include one or more processing units. In some embodiments, an application processor and a modem processor are integrated into the processor 1010. The application processor mainly processes an operating system, a user interface, an application, or the like. The modem processor mainly processes a wireless communication signal, for example, a baseband processor. It may be understood that, for example, the modem processor may not be integrated into the processor 1010.

The processor 1010 is configured to process first channel information into target channel characteristic information by using a first AI network model; and
the radio frequency unit 1001 is configured to: send the target channel characteristic information to a network side device, and send first information to the network side device, where the first information includes at least one of first indication information or target assistance information, where the first indication information indicates accuracy of second channel information recovered based on the target channel characteristic information or indicates information for assisting the network side device in determining the accuracy of the second channel information, and the target assistance information is used to assist the network side device in recovering the second channel information based on the target channel characteristic information.

In some embodiments, the first indication information indicates at least one of the following:
a representation parameter of the first channel information;
a correlation measure between the first channel information and the second channel information; or
the correlation measure meets a preset condition, or the correlation measure does not meet the preset condition.

In some embodiments, the terminal 1000 is further configured to obtain the second channel information by using at least one of the following manners:
recovering the second channel information through the processor 1010 by using a second AI network model based on the target channel characteristic information, where the second AI network model is related to a third AI network model used by the network side device, and the third AI network model is used to recover the second channel information based on the target channel characteristic information;
determining the second channel information based on a channel estimation result of a demodulation reference signal sent by the network side device and obtained by the radio frequency unit 1001; or
determining the second channel information based on a first reference signal obtained on at least some ports by the radio frequency unit 1001, where the first reference signal is a precoded reference signal, and precoding information of the first reference signal includes the second channel information recovered by the network side device by using the third AI network model based on the target channel characteristic information.

In some embodiments, the radio frequency unit 1001 is further configured to receive related information of the third AI network model from the network side device; and
the processor 1010 is further configured to determine the second AI network model based on the related information of the third AI network model.

In some embodiments, the correlation measure between the first channel information and the second channel information includes at least one of the following:
a correlation parameter of channel matrices corresponding to the first channel information and the second channel information respectively;
a correlation parameter obtained after the channel matrices corresponding to the first channel information and the second channel information respectively are mapped to a target transform domain, where the target transform domain includes at least one of an angle delay domain and a delay Doppler domain;
a power difference between equivalent channels corresponding to the first channel information and the second channel information respectively;
a difference between throughputs corresponding to the first channel information and the second channel information respectively;
a difference between CQI corresponding to the first channel information and the second channel information respectively; or
a norm of a difference between the channel matrices corresponding to the first channel information and the second channel information respectively.

In some embodiments, indication information that the correlation measure meets the preset condition includes at least one of the following:
the correlation measure is in a preset quantitative relationship with a preset threshold, where the preset threshold is a preset constant, or the preset threshold includes a correlation measure value determined based on a feedback result of historical channel characteristic information; or
a quantity of times that the correlation measure is in the preset quantitative relationship with the preset threshold is less than a preset quantity of times;
and/or
indication information that the correlation measure does not meet the preset condition includes at least one of the following:
the correlation measure is in a non-preset quantitative relationship with a preset threshold, where the preset threshold is a preset constant, or the preset threshold includes a correlation measure value determined based on a feedback result of historical channel characteristic information; or
a quantity of times that the correlation measure is in the non-preset quantitative relationship with the preset threshold is greater than or equal to the preset quantity of times.

In some embodiments, that the radio frequency unit 1001 sends first information to the network side device includes:
sending the first information to the network side device in a case that the correlation measure between the first channel information and the second channel information meets the preset condition.

In some embodiments, before the radio frequency unit 1001 sends the first information to the network side device, the processor 1010 is further configured to determine the target assistance information by using a fourth AI network model based on second information, where the second information includes at least one of the following:
the first channel information; or
the target channel characteristic information.

In some embodiments, the target channel characteristic information includes channel characteristic information in a first length, the target assistance information includes channel characteristic information in a second length or a part in the channel characteristic information in the second length other than the channel characteristic information in the first length, and the second length is greater than the first length.

In some embodiments, the first length is a quantity of bits of the target channel characteristic information or a quantity of coefficients included in the target channel characteristic information; and/or
the second length is a length of channel characteristic information obtained after the first AI network model processes the first channel information.

In some embodiments, the target channel characteristic information is obtained by the terminal processing the first channel information by using the fourth AI network model; and/or
the target channel characteristic information includes part of the channel characteristic information obtained after the first AI network model processes the first channel information, and the target assistance information includes all of the channel characteristic information obtained after the first AI network model processes the first channel information or part of the channel characteristic information other than the target channel characteristic information.

In some embodiments, the radio frequency unit 1001 is further configured to receive first configuration information, where the first configuration information is used to configure a target uplink resource; and
that the radio frequency unit 1001 sends first information to the network side device includes:
sending the first information to the network side device by using the target uplink resource.

In some embodiments, the radio frequency unit 1001 is further configured to receive second configuration information, where the second configuration information carries target period information; and
that the radio frequency unit 1001 sends first information to the network side device includes:
periodically sending the first information to the network side device based on the target period information.

In some embodiments, that the radio frequency unit 1001 sends first information to the network side device includes:

The radio frequency unit 1001 sends the first information to the network side device in a case of receiving second indication information, where the second indication information is used to trigger reporting of the first information.

In some embodiments, the first information and the target channel characteristic information are carried in a same CSI report.

The terminal 1000 provided in this embodiment of this application can implement the processes performed by the modules in the apparatus 700 for assisting in reporting channel characteristic information shown in FIG. 7, and a same effect can be achieved. To avoid repetition, details are not described herein again.

An embodiment of this application further provides a network side device, including a processor and a communication interface. The communication interface is configured to: obtain first information from a terminal, and obtain target channel characteristic information from the terminal, where the first information includes at least one of first indication information or target assistance information, the first indication information indicates accuracy of second channel information recovered based on the target channel characteristic information or indicates information for assisting the network side device in determining the accuracy of the second channel information, and the target assistance information is used to assist the network side device in recovering the second channel information based on the target channel characteristic information; and the processor is configured to determine the second channel information based on a channel recovery result of the target channel characteristic information obtained by using a third AI network model and the first information.

This network side device embodiment is corresponding to the foregoing method embodiment of the network side device. Each implementation process and implementation of the foregoing method embodiment may be applicable to this network side device embodiment, and a same technical effect can be achieved.

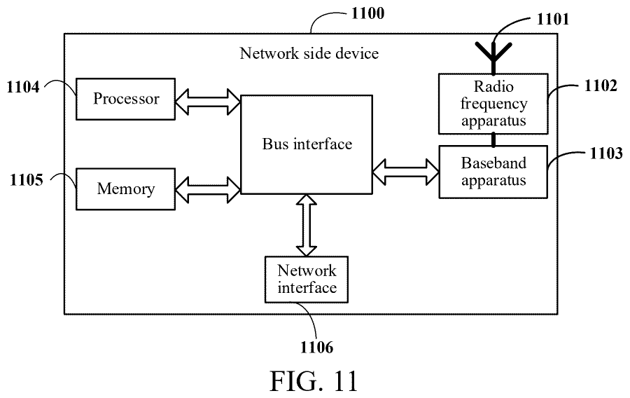

An embodiment of this application further provides a network side device. As shown in FIG. 11, the network side device 1100 includes: an antenna 1101, a radio frequency apparatus 1102, a baseband apparatus 1103, a processor 1104, and a memory 1105. The antenna 1101 is connected to the radio frequency apparatus 1102. In an uplink direction, the radio frequency apparatus 1102 receives information by using the antenna 1101, and sends the received information to the baseband apparatus 1103 for processing. In a downlink direction, the baseband apparatus 1103 processes to-be-sent information, and sends the to-be-sent information to the radio frequency apparatus 1102. After processing the received information, the radio frequency apparatus 1102 sends the information through the antenna 1101.

In the foregoing embodiment, the method performed by the network side device may be implemented in a baseband apparatus 1103. The baseband apparatus 1103 includes a baseband processor.

For example, the baseband apparatus 1103 may include at least one baseband board. A plurality of chips are disposed on the baseband board. As shown in FIG. 11, one chip is, for example, a baseband processor, and is connected to the memory 1105 by using a bus interface, to invoke a program in the memory 1105 to perform the operations of the network device shown in the foregoing method embodiment.

The network side device may further include a network interface 1106, and the interface is, for example, a Common Public Radio Interface (CPRI).

In some embodiments, the network side device 1100 in this embodiment of the present disclosure further includes: an instruction or a program stored in the memory 1105 and runnable on the processor 1104. The processor 1104 invokes the instruction or the program in the memory 1105 to perform the method performed by the modules shown in FIG. 8, and a same technical effect is achieved. To avoid repetition, details are not described herein again.

An embodiment of this application further provides a readable storage medium. A program or an instruction is stored in the readable storage medium. When the program or the instruction is executed by a processor, the processes of the method embodiment in FIG. 2 or FIG. 6 are implemented, and a same technical effect can be achieved. To avoid repetition, details are not described herein again.

The processor is a processor in the terminal in the foregoing embodiments. The readable storage medium includes a computer-readable storage medium, such as a computer ROM, a RAM, a magnetic disk, or an optical disc.

An embodiment of this application also provides a chip. The chip includes a processor and a communication interface. The communication interface is coupled to the processor, the processor is configured to run a program or an instruction, to implement the processes of the method embodiment shown in FIG. 2 or FIG. 6, and a same technical effect can be achieved. To avoid repetition, details are not described herein again.

In some embodiments, it should be understood that the chip mentioned in this embodiment of this application may be referred to as a system-level chip, a system chip, a chip system, or an on-chip system chip.

An embodiment of this application also provides a computer program/program product. The computer program/program product is stored in a storage medium, the computer program/program product is executed by at least one processor to implement the processes of the method embodiment shown in FIG. 2 or FIG. 6, and a same technical effect can be achieved. To avoid repetition, details are not described herein again.

An embodiment of this application further provides a communication system, including: a terminal and a network side device, where the terminal may be configured to perform the steps of the embodiment of the method for assisting in reporting channel characteristic information as shown in FIG. 2, and the network side device may be configured to perform the steps of the embodiment of the method for restoring channel characteristic information as shown in FIG. 6.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to such process, method, article, or apparatus. In absence of more constraints, an element preceded by a statement “includes a . . . ” does not preclude the presence of additional identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software along with any necessary universal hardware platform or by hardware only. Based on such an understanding, the technical solutions of this application essentially or the part contributing to the prior art may be implemented in a form of a computer software product. The computer software product is stored in a storage medium (such as a ROM/RAM, a hard disk, or an optical disc), and includes several instructions for instructing a terminal (which may be a mobile phone, a computer, a server, an air-conditioner, a network device, or the like) to perform the method described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A method for assisting in reporting channel characteristic information, comprising:
processing, by a terminal, first channel information into target channel characteristic information by using a first AI network model; and
sending, by the terminal, the target channel characteristic information to a network side device, and sending first information to the network side device, wherein the first information comprises at least one of first indication information or target assistance information;
wherein the first indication information indicates accuracy of second channel information recovered based on the target channel characteristic information or indicates information for assisting the network side device in determining the accuracy of the second channel information, and the target assistance information is used to assist the network side device in recovering the second channel information based on the target channel characteristic information.

2. The method according to claim 1, wherein the first indication information indicates at least one of the following:
a representation parameter of the first channel information;
a correlation measure between the first channel information and the second channel information; or
the correlation measure meets a preset condition, or the correlation measure does not meet the preset condition.

3. The method according to claim 2, further comprising:
obtaining, by the terminal, the second channel information by using at least one of the following manners:
recovering the second channel information by using a second AI network model based on the target channel characteristic information, wherein the second AI network model is related to a third AI network model used by the network side device, and the third AI network model is used to recover the second channel information based on the target channel characteristic information;
determining the second channel information based on a channel estimation result of a demodulation reference signal sent by the network side device; or
determining the second channel information based on a first reference signal obtained on at least a subset of ports, wherein the first reference signal is a precoded reference signal, and precoding information of the first reference signal comprises the second channel information recovered by the network side device by using the third AI network model based on the target channel characteristic information.

4. The method according to claim 3, further comprising:
receiving, by the terminal, related information of the third AI network model from the network side device; and
determining, by the terminal, the second AI network model based on the related information of the third AI network model.

5. The method according to claim 2, wherein the correlation measure between the first channel information and the second channel information comprises at least one of the following:
a correlation parameter of channel matrices corresponding to the first channel information and the second channel information respectively;
a correlation parameter obtained after the channel matrices corresponding to the first channel information and the second channel information respectively are mapped to a target transform domain, wherein the target transform domain comprises at least one of an angle delay domain or a delay Doppler domain;
a power difference between equivalent channels corresponding to the first channel information and the second channel information respectively;
a difference between throughputs corresponding to the first channel information and the second channel information respectively;
a difference between channel quality indicators corresponding to the first channel information and the second channel information respectively; or
a norm of a difference between the channel matrices corresponding to the first channel information and the second channel information respectively.

6. The method according to claim 5, wherein indication information of the correlation measure meets the preset condition comprises at least one of the following:
the correlation measure is in a preset quantitative relationship with a preset threshold, wherein the preset threshold is a preset constant, or the preset threshold comprises a correlation measure value determined based on a feedback result of historical channel characteristic information; or
a quantity of times that the correlation measure is in the preset quantitative relationship with the preset threshold is less than a preset quantity of times;
or
indication information of the correlation measure does not meet the preset condition comprises at least one of the following:
the correlation measure is in a non-preset quantitative relationship with a preset threshold, wherein the preset threshold is a preset constant, or the preset threshold comprises a correlation measure value determined based on the feedback result of historical channel characteristic information; or
a quantity of times that the correlation measure is in the non-preset quantitative relationship with the preset threshold is greater than or equal to the preset quantity of times.

7. The method according to claim 6, wherein the sending, by the terminal, the first information to the network side device comprises:
sending, by the terminal, the first information to the network side device when the correlation measure between the first channel information and the second channel information meets the preset condition.

8. The method according to claim 1, wherein before the sending, by the terminal, the first information to the network side device, the method further comprises:
determining, by the terminal, the target assistance information by using a fourth AI network model based on second information, wherein the second information comprises at least one of the following:
the first channel information; or
the target channel characteristic information.

9. The method according to claim 8, wherein the target channel characteristic information comprises channel characteristic information in a first length, the target assistance information comprises channel characteristic information in a second length or part of the channel characteristic information in the second length other than the channel characteristic information in the first length, and the second length is greater than the first length.

10. The method according to claim 9, wherein the first length is a quantity of bits of the target channel characteristic information or a quantity of coefficients comprised in the target channel characteristic information; or
the second length is a length of channel characteristic information obtained after the first AI network model processes the first channel information.

11. The method according to claim 9, wherein the target channel characteristic information is obtained by the terminal processing the first channel information by using the fourth AI network model; or
the target channel characteristic information comprises part of the channel characteristic information obtained after the first AI network model processes the first channel information, and the target assistance information comprises all of the channel characteristic information obtained after the first AI network model processes the first channel information or part of the channel characteristic information other than the target channel characteristic information.

12. The method according to claim 1, further comprising:
receiving, by the terminal, first configuration information, wherein the first configuration information is used to configure a target uplink resource,
wherein the sending, by the terminal, the first information to the network side device comprises:
sending, by the terminal, the first information to the network side device by using the target uplink resource.

13. The method according to claim 1, further comprising:
receiving, by the terminal, second configuration information, wherein the second configuration information carries target period information,
wherein the sending, by the terminal, the first information to the network side device comprises:
periodically sending, by the terminal, the first information to the network side device based on the target period information.

14. A method for restoring channel characteristic information, comprising:
obtaining, by a network side device, first information from a terminal, and obtaining target channel characteristic information from the terminal, wherein the first information comprises at least one of first indication information or target assistance information, the first indication information indicates accuracy of second channel information recovered based on the target channel characteristic information or indicates information for assisting the network side device in determining the accuracy of the second channel information, and the target assistance information is used to assist the network side device in recovering the second channel information based on the target channel characteristic information; and
determining, by the network side device, the second channel information based on a channel recovery result of the target channel characteristic information obtained by using a third AI network model and the first information.

15. The method according to claim 14, wherein the determining, by the network side device, the second channel information based on a channel recovery result of the target channel characteristic information obtained by using the third AI network model and the first information comprises:
determining, by the network side device based on the first information, whether to update the third AI network model; and
when the network side device determines to update the third AI network model, restoring the second channel information by using the updated third AI network model based on the target channel characteristic information,
wherein the method further comprises:
sending, by the network side device, a related parameter of the updated first AI network model to the terminal, or sending a related parameter of the updated first AI network model and the updated third AI network model to the terminal, wherein the updated first AI network model is associated with the updated third AI network model.

16. The method according to claim 14, wherein the determining, by the network side device, the second channel information based on the channel recovery result of the target channel characteristic information obtained by using he third AI network model and the first information comprises:
restoring, by the network side device, the third channel information by using the third AI network model based on the first information or the target channel characteristic information, and processing the target assistance information and the third channel information by using a fifth AI network model, to obtain the second channel information; or
processing, by the network side device, the target channel characteristic information into third information by using the third AI network model, and restoring the second channel information by using the fifth AI network model based on the target assistance information and the third information.

17. The method according to claim 14, wherein the first indication information indicates at least one of the following:
a representation parameter of first channel information;
a correlation measure between the first channel information and the second channel information; or
the correlation measure meets a preset condition, or the correlation measure does not meet the preset condition.

18. The method according to claim 17, further comprising:
sending, by the network side device, related information of the third AI network model to the terminal, wherein the terminal recovers the second channel information by using a second AI network model based on the target channel characteristic information, and the second AI network model corresponds to the third AI network model; or
determining, by the network side device, a demodulation reference signal based on the second channel information, and sending the demodulation reference signal to the terminal; or
precoding, by the network side device, a first reference signal based on the second channel information, and sending the precoded first reference signal to the terminal.

19. The method according to claim 14, wherein the target channel characteristic information comprises channel characteristic information in a first length, the target assistance information comprises channel characteristic information in a second length or part of the channel characteristic information in the second length other than the channel characteristic information in the first length, and the second length is greater than the first length.

20. The method according to claim 14, further comprising:
sending, by the network side device, first configuration information to the terminal, wherein the first configuration information is used to configure a target uplink resource,
wherein the obtaining, by the network side device, the first information from the terminal comprises:
obtaining, by the network side device, the first information from the terminal by using the target uplink resource.
